(19) United States
(12) Patent Application Publication
(10) Pub. No.: US 2008/0110767 A1
(43) Pub. Date: May 15, 2008

(54) PROCESS FOR ELECTROCHEMICAL DECOMPOSITION OF SUPERALLOYS

(75) Inventors: Viktor Stoller, Bad Harzburg (DE); Armin Olbrich, Seesen (DE); Juliane Meese-Marktscheffel, Goslar (DE); Wolfgang Mathy, Langelsheim (DE); Michael Erb, Salzgitter (DE); Georg Nietfeld, Bad Harzburg (DE); Gerhard Gille, Goslar (DE)

Correspondence Address: Connolly Bove Lodge & Hutz LLP, 1007 North Orange Street, P.O. Box 2207, Wilmington, 19899, omitted

(73) Assignee: H.C. Starck GmbH, Goslar (DE)

(21) Appl. No.: 11/741,347

(22) Filed: Jun. 21, 2007

Related U.S. Application Data
(63) Continuation of application No. 10/292,321, filed on Nov. 12, 2002, now abandoned.

(30) Foreign Application Priority Data
Nov. 14, 2001 (DE) 101 55 791.4

(51) Int. Cl. B23H 3/00

(52) U.S. Cl. 205/704

(57) ABSTRACT

A process for recovery of valuable metals from superalloys by electrochemical decomposition is described, both electrodes being formed by the superalloy and the polarity of the electrolysis current being reversed with a frequency of from 0.005 to 5 Hz.

### BACKGROUND OF THE INVENTION

1. Field of the Invention

The present invention relates to a process for electrochemical decomposition of superalloys, in particular superalloy scrap, with the particular purpose of recovering rare and valuable metals such as rhenium, platinum, tantalum and hafnium.

2. Brief Description of the Prior Art

Superalloys are high melting, high strength and extremely wear-resistant alloys of a comparatively large number of metals, which are used predominantly in turbine construction, especially aircraft turbines. Their special properties are owed in part to the addition of very rare and expensive elements, for example tantalum, hafnium or even rhenium/platinum. Because of their tough nature, it is difficult to recycle them, and to date they are not recycled economically, after their service life.

This has led to irretrievable loss of these high value, strategic raw materials with limited availability, owing to fusion of the said superalloy scrap into normal steels, on the order of, for example, up to 10 t/a (tons per year) of rhenium and 30 t/a of tantalum. Just by itself, the rhenium quantity of 10 t/a corresponds to approximately one third of the world's primary production per year. Hence the lack of recycling constitutes a waste of resources not only in economic terms but also in terms of the “responsible care” concept adopted by the chemical industry. As to tantalum, although it is not itself as rare as rhenium, it nevertheless occurs naturally only to a very limited extent in the form of workable ores. Additionally, appreciable quantities have been obtained from Sn slag containing Ta, which originate predominantly in Thailand and Malaysia. At any rate, because of the explosive development of the electronics industry, requiring constantly increasing demand for tantalum, the supply of this raw-material is becoming ever weaker. Therefore, it is economically and strategically sensible to recycle superalloys with Ta contents of up to 8%.

While there are a number of pyro- and hydrometallurgical approaches for recovering the metallic constituents of superalloys, they are not economically suitable because of their cost-intensive complexity or their time-consuming nature . For example, it is known to melt superalloys under a protective-gas atmosphere, subsequently spray the melt to form a finely divided powder, and then decompose the powder by using a time-consuming treatment with inorganic acids. It would also be conceivable to comminute superalloy-part scrap after prior suitable embrittlement by elaborate grinding processes, but this would be just as expensive. For, because of its high strength, toughness and extraordinary wear resistance, such superalloy scrap necessitates preparation processes/grinding specially tailored/developed for these material classes. The actual decomposition of the alloy is in turn carried out wet-chemically by heat treatment in mineral acids of suitable concentration and composition (see, for example, Potter et al., Eff. Technol. Recycling Metal 1971, 35). In order to separate the Re from the solutions containing multiple metals, solvent extraction combined with sulphide precipitation reactions and electrodeposition reactions may, for example, be used (see, for example, Churchwood et al., J. Metals, 1963, September, 648).

A good summary of oxidative, pyrometallurgical and hydrometallurgical is provided in an article by Kenworthy et at. (Experimental Extraction of Strategic Components from S-816 Alloy Scrap, Report of Investigations 5786, United States Department Of The Interior, Bureau Of Mines, 1976), in which electrolytic corrosion studies are also described. The report described decomposition tests on the special example of S816 scrap, a Re/Ta-free Co-based alloy (40+%) with high proportions of Cr (20%) and Ni (20%) as well as, inter alia, Fe, Nb, W and Mo in the 4% range. The use of sulphuric acid as a corrosive electrolyte medium at 7×10⁻⁵ Hz (polarity reversal every 4 hours) is in this case presented as being best suited to this type of scrap. Hydrated (Co, Ni, Fe) sulphate mixtures are subsequently crystallised from the electrolyte solution at −20° C. and subjected to Intermediate consecutive processing operations.

Further processes which relate to the decomposition of alloy scrap by using electrochemical processes are:
U.S. Pat. No. 3,649,487, the high-melting metals (Cr/Mo/W) contained in scrap of an Fe/Ni/Co/Cu-based alloy are first thermally converted (by a melting process) into carbides, borides, silicides, nitrides or phosphides by adding non-metallic compounds of group III, IV or V, fused to form anodes, or connected as anodes, and then subjected to anodic oxidation. In this case, Ni, Co and Cu are cathodically deposited, whereas the high-melting metals remain in the anode slime as, for example, carbides. Regarding this recycling of Ni, Co or copper, there is a lack of any information about current, current density, anodic/cathodic current efficiency, precise electrolyte composition, completeness of the separation, as well as estimable space-time yields or information about economic viability.
An article by Venkatachalam et al (J. Electrochem. Soc. India, 1986, 35-2, 127) studies the effect of current density, electrolyte concentration, electrolysis time and alternating-current frequency on the effectiveness of dissolving Ni when electrolysing nickel-based superalloy scrap in acids. In this case, however, the lowest selected alternating-current frequency was 25 Hz (screened range: 25-150 Hz).
According to WO 96/14440, a decomposition process, which is based on anodic oxidation of the alloy in an electrolysis bath with a protic, organic solvent component, is used in order to recover the metallic constituents from superalloys. This patent specification states that at most 10% water may be added to the electrolyte solution, so that the process still functions according to the invention (otherwise formation of a gel which is difficult to process and passivation of the anode surface and therefore termination of the electrolysis). The electrolytically obtained filtration residue is processed, for example, thermally by calcination after mixing into milk of lime) the calcination product, for its part, being subsequently processed further by customary hydrometallurgical separating operations.

### SUMMARY OF THE INVENTION

The present invention therefore relates to a process for decomposition of superalloys, wherein both electrodes of an electrochemnical cell are formed by the superalloy to be decomposed, and the polarity of the electrolysis current is reversed with a frequency of from 0.005 to 5 Hz, preferably from 0.08 to 2 Hz, and particularly preferably from 0.01 to 1 Hz. In the context of the present invention, superalloys are alloys which contain from 50 to 75 wt. % of nickel as the major component, respectively from 3 to 15 wt. % of at least one of the elements cobalt, chromium and optionally aluminium, as well as from 1 to 10 wt. % of one or more of the elements tantalum, niobium, tungsten, molybdenum, rhenium, platinum and hafnium.

Such superalloys are not susceptible to decomposition by means of direct-current electrolysis in aqueous solutions, since a superficial passivation layer is formed after only a short electrolysis time, which then brings the electrolysis current to a standstill.

### BRIEF DESCRIPTION OF THE DRAWINGS

FIG. 1 is a schematic representation of the process from the identification of the superalloy scrap (1), electrolytic dissolving (2), suspension (3), filtration/washing (4) and further processing variants (5) and (6) respectively in order to recover valuable materials, in particular rhenium, platinum, tantalum and hafnium.

FIG. 2 is a schematic representation of three variants for the processing (6) of the filtrate (4.2) containing Ni/Co/Cr/Al part of the Re/majority of the Mo.

### DETAILED DESCRIPTION OF THE INVENTION

It has been found that electrolytic decomposition can be carried out very favourably and effectively if a very low-frequency electrolysis current is used. Surprisingly, current efficiencies of up to 150%, in general between 120 and 140%, have been found in this case to be effective, which lead to the conclusion that a chemical dissolving process is also taking place besides the electrolytic dissolving. While the underlying mechanism of this additional chemical dissolving process is not fully understood, it is conceivable that, by evolution of gas, the passivation layer becomes detached with the inclusion of metallic constituents, which are then exposed to oxidation by acid attack, or that boundary-layer effects or effects in conjunction with the build-up and breakdown of boundary layers lead to the increased current efficiency.

According to the invention, an inorganic acid is used as the electrolyte, preferably hydrochloric acid, and particularly preferably a hydrochloric cid solution with an HCO content of from 15 to 25 wt. %. Nevertheless, mixtures of hydrochloric acid and sulphuric acid may also be used advantageously if subsequent stages and refluxes are taken into account.

The electrolysis is advantageously conducted with an electrolysis-current density of from 80 to 600 mA/cm² of cross-sectional area of the electrolysis cell. In this case, the electrolysis voltage between the electrodes is between 2 and 6 volts, depending on the electrolyte conductivity, the current density and the spacing of the electrodes. According to the invention, the electrochemical decomposition is preferably carried out at a constant electrolysis current. Preferably, the temperature in the electrolysis cell is from 20 to 100° C., and particularly preferably from 60 to 80° C.

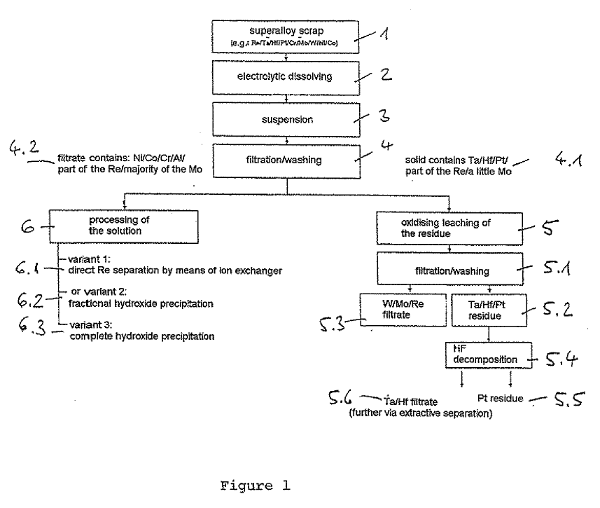

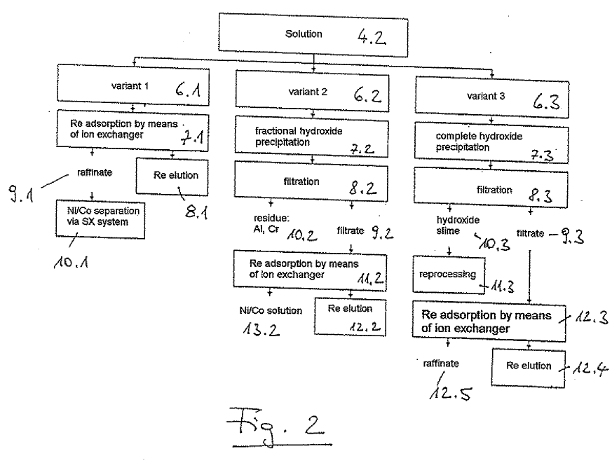

The superalloy electrochemically decomposed according to the invention is subsequently processed, in a manner which is known per se, in order to recover the valuable materials, in particular rhenium, platinum, tantalum and hafnium. This aspect of the invention is further described with particular reference to the drawings. This is represented schematically in the appended FIGS. 1 and 2. According to FIG. 1, the superalloy, which may contain the elements rhenium, tantalum, hafnium, platinum, chromium, molybdenum, tungsten, nickel and cobalt, is electrochemically decomposed according to the invention (2); a suspension (3) is produced, from which a filter residue (4.1), which contains the elements tantalum, hafnium and platinum, as well as part of the rhenium and a little molybdenum, is obtained after filtration and optionally washing the filter residue (4). The elements nickel, cobalt chromium and aluminium, part of the rhenium and the majority of the molybdenum are contained in the filtrate (4.2).

For further processing, the filter residue (4.1) is further decomposed of oxidising leaching (5) by suspending in fully deionised water, adding sodium hydroxide solution, heating to a temperature of from 65 to 90° C., supplementing with hydrogen peroxide while stirring. The cooled suspension is filtered (5.1) and the filter residue is washed. The filtrate (5.3), which contains the tungsten, molybdenum and part of the rhenium and a little Pt, can be separated further, in a manner which is known per se, by means of strongly basic ion exchangers. The filter residue (5.2) containing the valuable tantalum, hafnium and platinum is, if platinum is present, processed further via hydrofluoric acid decomposition (5.4) to solubilize the valuable tantalum/hafnium. The residue of the HF decomposition (5.4) contains the valuable platinum (5.5). The filtrate (5.6) contains the valuable tantalum/hafnium, which can be separated further by extraction with MIBK.

Three variants, which are explained in FIG. 2, are available for the processing (6) of the filtrate (4.2) which has been obtained from the filtration (4). According to variant 1 (6.1) the filtrate (4.2) from FIG. 1 is sent through an ion exchanger (7.1) and the rhenium is obtained as an eluate (8.1). From the raffinate (9.1), the nickel/cobalt units can be separated (10.1 ) via a solvent-extraction (SX) system.

According to variant 2 (6.2), the filtrate (4.2) is subjected to fractional hydroxide precipitation (7.2); after filtration (8.2), a residue (10.2) containing aluminium and chromium is obtained and a filtrate (9.2), from which rhenium is separated by means of an ion exchanger (11.2) and is recovered by elution (12.2). The raffinate (13.2) consists of a nickel/cobalt solution.

According to variant 3 (6.3) complete hydroxide precipitation (7.3) is carried out, after filtration (8.3), the hydroxide slime (10.3) which is obtained also contains nickel and cobalt. The hydroxide slime can be reprocessed in the usual way (11.3). From the filtrate (9.3) of the filtration (8.3), rhenium is adsorbed by means of an ion exchanger (12.3) and is recovered by elution (12.4).

### EXAMPLE

10.4 kg of dilute hydrochloric acid solution (18.5 wt. %) are placed in a 15-liter electrolysis cell made of polypropylene. Two titanium baskets filled with superalloy scrap, with a total scrap content of 8.0 kg (composition, wt. %, 8.5 Ta, 3.1 Re, 5.8 W, 9.8 Co, 60.9 Ni, 4.9 Cr, 5.1 Al, 1.9 Mo) are used as the electrodes. The electrode spacing is approximately 2 cm. The electrolytic dissolving is carried out at 70° C. by means of a square-wave current at a frequency of 0.5 Hz, a current of 50 amperes and a resulting voltage of approximately 3 to 4 volts. After an electrolysis time of 25 hours, the amount of scrap detached or dissolved is 1.6 kg. The resulting suspension is filtered and the residue (1) is washed with 0.63 kg of fully deionised water.

The 0.422 kg of filtration residue (1) contains wt. %: 39.5 Ta₂O₅, 6.2 ReO₂, 27.8 WO₃, 1.6 MoO₃ and 25 H₂O. The filtrate is purified with the wash water and wt. %: 0.3 HReO₄, 0.4 H₂MoO₄, 2.8 CoCl₂, 17.6 NiCl₂, 1.9 CrCl₃, 3.3 AlCl₃ and 0.2 HCl are found in solution (1).

### Processing of the Filtration Residue (11)

The wet filtration residue is suspended in 195 g of fully deionised water in a 2-liter beaker while stirring, supplemented with 160 g of 50% strength sodium hydroxide solution and heated to 80° C. 41 g of 30% strength hydrogen peroxide solution are then introduced. After 2 hours of stirring at 80° C., the suspension is cooled, filtered and the residue is washed with 0.370 kg of fully deionised water. The 0.222 kg of filtration residue (2) contains wt. %: 74.9 Ta₂O₅, 0.1 ReO₂, 1.0 W0₃ and 23.0 H₂0. The filtrate is purified with the wash water and wt. %: 2.3 NaReO₄, 10.6 Na₂Wo₄, 0.7 Na₂MoO₄ and 2.2 NaOH are found in solution (2).

### Processing of the Filtration Residue (2)

Tungsten and rhenium are separated in a known manner by means of strongly basic ion-exchange resins, and can thereafter be sent to the further value chain as precursors for the production of tungsten and rhenium products.

### Processing of the Solution (1)

4,3 kg of 50% strength sodium hydroxide solution are added to the solution in a 20-liter stirred rector and thermally regulated to 80° C. After a reaction time of 2 hours, the suspension is filtered and the residue is washed with 6.5 kg of fully deionised water. The resulting 3.96 kg of filtration residue (3) contains wt. %: 6 Al(OH)₃, 6.2 Co(OH)₂, 38.9 Ni(OH)₂ 3.9 Cr(OH)₃, 45 H₂O. The filtrate is purified with the wash water and wt. %: 6 Al(OH)₃, 6.2 Co(OH)₂, 38.9 Ni(OH)₂, 38.9 Ni(OH)₂, 3.9 Cr(OH)₃, 45 H₂O are found in solution (3). The filtrate is purified with the wash water and %: 0.2 NaReO₄ and 0.3 Na₂MoO₄ are found in solution (3).

### Processing of the Solution (3)

Molybdenum and rhenium are separated in a known manner by means of strongly basic ion-exchange resins, and can thereafter be used as precursors for the production of molybdenum and rhenium products.

### Processing of the Filtration Residue (3)

The filtration residue can be reprocessed in a known manner, for example reducing melt to form Ni—Co alloys.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1-8. (canceled)

9. A process of recovering valuable metals from superalloys comprising, decomposing a superalloy electrochemically in an apparatus comprising an anode and a cathode, and with an electrolysis voltage and an electrolysis current, wherein,
(i) the superalloy is used both as the anode and as the cathode,
(ii) the polarity of the electrolysis current is reversed with a frequency of from 0.005 to 5 Hz,
(iii) said electrolysis voltage is from 2 to 6 volts, and
(iv) said electrolysis current is constant.

10. The process of claim 9, wherein the superalloy contains one or more of the metals Co, Ni, Cr or Al as major constituents and one or more of the elements Ta, Re, W, Mo, Hf or Pt as minor constituents.

11. The process of claim 10, wherein the superalloy contains from 1 to 10 wt. % of Re.

12. The process of claim 9, wherein the electrochemical decomposition is performed in the presence of an electrolyte, and said electrolyte is an inorganic acid.

13. The process of claim 12, wherein said inorganic acid is an oxygen-free inorganic acid.

14. The process of claim 11, wherein the electrochemical decomposition is performed in the presence of an electrolyte, and said electrolyte is an inorganic acid.

15. The process of claim 14, wherein said inorganic acid is an oxygen-free inorganic acid.

16. The process of claim 15, wherein as a result of the electrochemical decomposition, the elements Co, Ni, Cr and Al are obtained as salts dissolved in an electrolysis brine, and
the elements Ta, W, Hf and Pt are obtained as filterable oxides,
so that essentially quantitative separation of the two element groups can be carried out by filtration of the electrolysis brine.

17. The process of claim 12, wherein said oxygen-free inorganic acid is HCl, and said electrolyte comprises 15 to 25 weight percent of HCl.
